(19) United States
(12) Patent Application Publication
(10) Pub. No.: US 2020/0097887 A1
(43) Pub. Date: Mar. 26, 2020

(54) SCHEDULE MANAGEMENT DEVICE AND SCHEDULE MANAGEMENT METHOD

(71) Applicant: TOYOTA JIDOSHA KABUSHIKI KAISHA, Toyota-shi (JP)

(72) Inventor: Takashige HORI, Aisai-shi (JP)

(73) Assignee: TOYOTA JIDOSHA KABUSHIKI KAISHA, Toyota-shi (JP)

(21) Appl. No.: 16/535,182

(22) Filed: Aug. 8, 2019

(30) Foreign Application Priority Data
Sep. 21, 2018 (JP) 2018-177391

(51) Int. Cl. G06Q 10/06; G06Q 10/10

(52) U.S. Cl. CPC G06Q 10/063116; G06Q 10/1093

(57) ABSTRACT

In a schedule management device, a schedule acquirer acquires schedule information, which includes a scheduled time, of a user. A vacant time detector detects, when the start time of a schedule item in acquired schedule information is delayed or when the finish time of a schedule item is in acquired schedule information advanced, the difference from the original start time or the original finish time as a vacant time of the user. A deriver derives action proposal information available for a detected vacant time and related to the action plan of a future schedule item.

### BACKGROUND

### 1. Technical Field

The present disclosure relates to a technology using schedule information of a user, in which a start time and a finish time are set.

### 2. Description of Related Art

JP-A-2014-241108 discloses an action proposal device that makes an action proposal for a user's vacant time. The action proposal device acquires a vacant time based on a future schedule and proposes visiting a facility, which suits the user's preferences, during the vacant time.

[Patent Document 1] Japanese Unexamined Patent Application Publication No. 2014-241108 (JP-A-2014-241108)

In the technology disclosed in JP-A-2014-241108, a vacant time is acquired based on a schedule managed by an information processing device, but, if the user does not input his or her daily routine to the schedule, there may be a case where an acquired vacant time is actually not a vacant time.

### SUMMARY

A general purpose of the present disclosure is to provide a technology for accurately detecting a user's vacant time.

In response to the above issue, a schedule management device of one embodiment of the present disclosure includes: a schedule acquirer configured to acquire schedule information of a user, in which a start time and a finish time are set; and a vacant time detector configured to detect, when the start time of a schedule item in acquired schedule information is delayed or when the finish time of a schedule item in acquired schedule information is advanced, the difference from the original start time or the original finish time as a vacant time of the user.

Another embodiment of the present disclosure relates to a schedule management method. The schedule management method includes: acquiring schedule information of a user, in which a start time and a finish time are set; and detecting, when the start time of a schedule item in acquired schedule information is delayed or when the finish time of a schedule item in acquired schedule information is advanced, the difference from the original start time or the original finish time as a vacant time of the user.

### BRIEF DESCRIPTION OF THE DRAWINGS

Embodiments will now be described, by way of example only, with reference to the accompanying drawings that are meant to be exemplary, not limiting, and wherein like elements are numbered alike in several figures, in which:

FIG. 1 is a diagram used to describe a configuration of a schedule management system;

FIG. 2A is a diagram used to describe detection of a vacant time performed by a schedule management device;

FIG. 2B is a diagram following FIG. 2A and used to describe detection of a vacant time performed by a schedule management device;

FIG. 3A is a diagram following FIG. 2B and used to describe proposal of an action for a vacant time;

FIG. 3B is a diagram following FIG. 3A and used to describe proposal of an action for a vacant time;

FIG. 4 is a diagram used to describe a functional configuration of the schedule management device; and FIG. 5 is a flowchart of processing for proposing an action for a vacant time.

### DETAILED DESCRIPTION

An embodiment will now be described. The embodiment is illustrative and is not intended to be limiting.

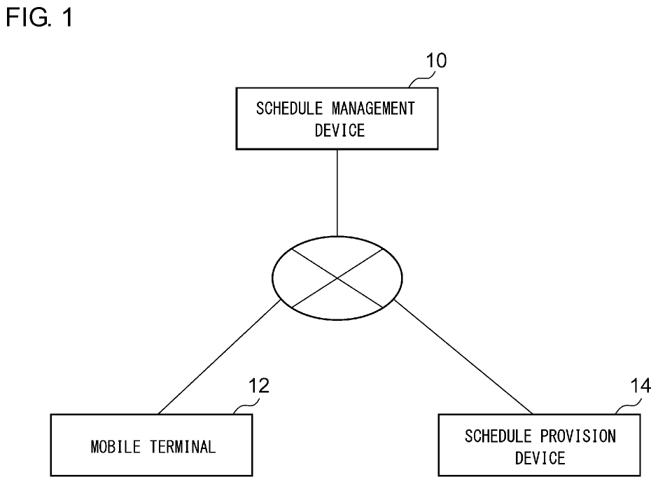

FIG. 1 is a diagram used to describe a configuration of a schedule management system 1. The schedule management system 1 includes a schedule management device 10, a mobile terminal 12, and a schedule provision device 14. The schedule management device 10, mobile terminal 12, and schedule provision device 14 are connected to one another via a network.

The mobile terminal 12, held by a user, transmits schedule information to the schedule provision device 14 upon input from the user, and receives schedule information from the schedule provision device 14 for confirmation of a schedule. For a schedule item in schedule information, a scheduled time, a subject, a place, and a participant are entered. The scheduled time is defined by a start time and a finish time, and means a time period from the start time to the finish time. The mobile terminal 12 also transmits, to the schedule management device 10, profile information and position information as user information. The profile information includes information indicating the age, gender, and preferences of the user, for example. When transmitting information to the schedule management device 10 and the schedule provision device 14, the mobile terminal 12 also transmits a terminal ID.

The schedule provision device 14 retains schedule information transmitted from the mobile terminal 12, and provides the schedule information upon request from the mobile terminal 12 and the schedule management device 10. When the schedule provision device 14 receives schedule information from the mobile terminal 12, i.e., when there is user input, the schedule provision device 14 may transmit the schedule information of the user to the schedule management device 10.

The schedule management device 10 monitors if the scheduled time of a schedule item included in the schedule information received from the schedule provision device 14 is changed, and, if a change of a scheduled time causes a vacant time, the schedule management device 10 will make an action proposal to the user. Such a change of a scheduled time causing a vacant time may be the case where the start time of the scheduled time is delayed, the case where the finish time of the scheduled time is advanced, or the both. If the user accepts the action proposal from the schedule management device 10, the schedule management device 10 will adds, to the schedule information retained in the schedule provision device 14, information of the accepted action proposal as a new schedule item.

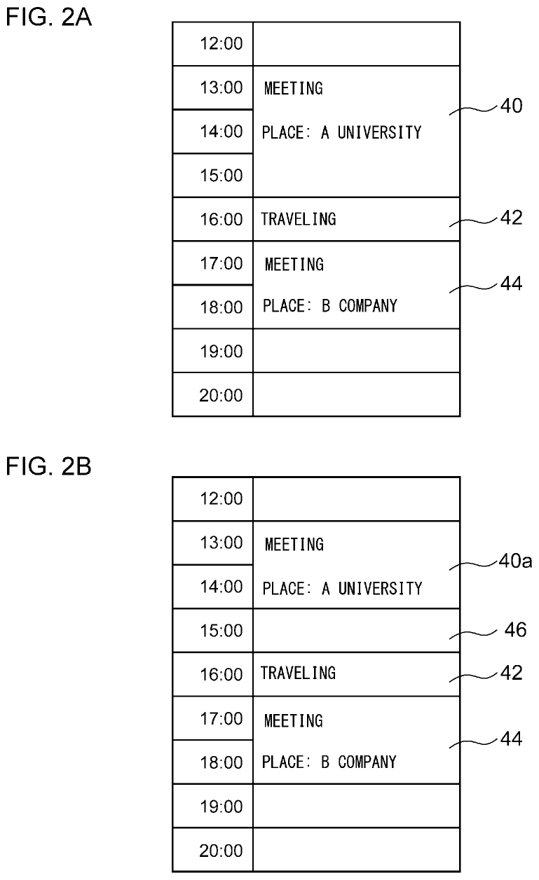

FIGS. 2A and 2B are diagrams used to describe detection of a vacant time performed by the schedule management device 10. FIGS. 2A and 2B show schedule information displayed on the display of the mobile terminal 12. In the schedule information shown in FIG. 2A, a first schedule item 40, a traveling item 42, and a second schedule item 44 are displayed in this order.

With regard to the first schedule item 40, the subject is “Meeting”, the place is “A University”, and the scheduled time is set to a period from 13:00 to 16:00. Also, with regard to the second schedule item 44, the subject is

“Meeting”, the place is “B Company”, and the scheduled time is set to a period from 17:00 to 19:00. The first schedule item 40 and the second schedule item 44 are set by user input, and the traveling item 42 is automatically set by the schedule provision device 14 based on the information regarding the places of the first schedule item 40 and the second schedule item 44.

Since the meeting of the first schedule item 40 has finished earlier, the user enters a first schedule item 40a, in which the finish time is set earlier, into the mobile terminal 12, and the information thus entered is transmitted to the schedule provision device 14. When the mobile terminal 12 transmits schedule information to the schedule provision device 14, the schedule provision device 14 provides the schedule information to the schedule management device 10. In FIG. 2B, the finish time is set earlier in the first schedule item 40a, causing a vacant time 46 from 15:00 to 16:00. The schedule management device 10 detects, as a vacant time, a time by which the scheduled time of the changed schedule item is reduced from the scheduled time of the schedule item before the change.

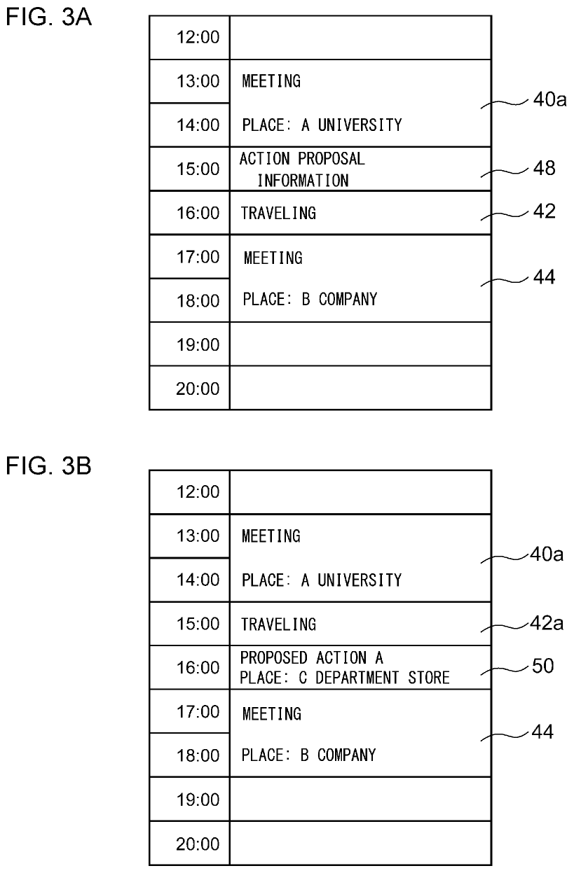

FIGS. 3A and 3B are diagrams following FIGS. 2A and 2B and used to describe proposal of an action for a vacant time. In FIG. 3A, action proposal information 48 is displayed on a display space for the vacant time 46 shown in FIG. 2B. This means that the schedule management device 10 displays action proposal information for the detected vacant time to make an action proposal to the user. The action proposal information may, for example, introduce a shop or an event near the user.

When the user performs an operation, such as tapping the action proposal information 48 displayed on the display of the mobile terminal 12, the display may shift to another page, for example, to display multiple pieces of action proposal information 48. By selecting one of the multiple pieces of action proposal information 48 displayed on the mobile terminal 12, the user can accept the action proposal. When the user accepts one of the pieces of action proposal information 48 proposed, information regarding the piece of action proposal information 48 thus accepted is transmitted from the mobile terminal 12 to the schedule management device 10.

In the schedule information shown in FIG. 3B, the piece of action proposal information 48 accepted by the user is added and displayed as a third schedule item 50. Also, the scheduled time of a traveling item 42a is shifted from that of the traveling item 42 shown in FIG. 2A. The scheduled time has been changed because the place of the third schedule item 50, C Department Store, is located near the place of the second schedule item 44. Thus, the schedule management device 10 can add, to schedule information, a piece of action proposal information 48 accepted by the user as a new schedule item and change the schedule information.

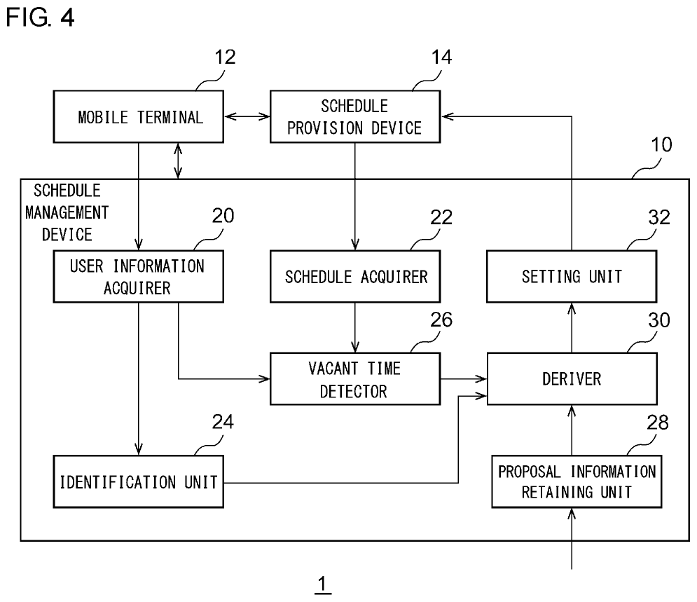

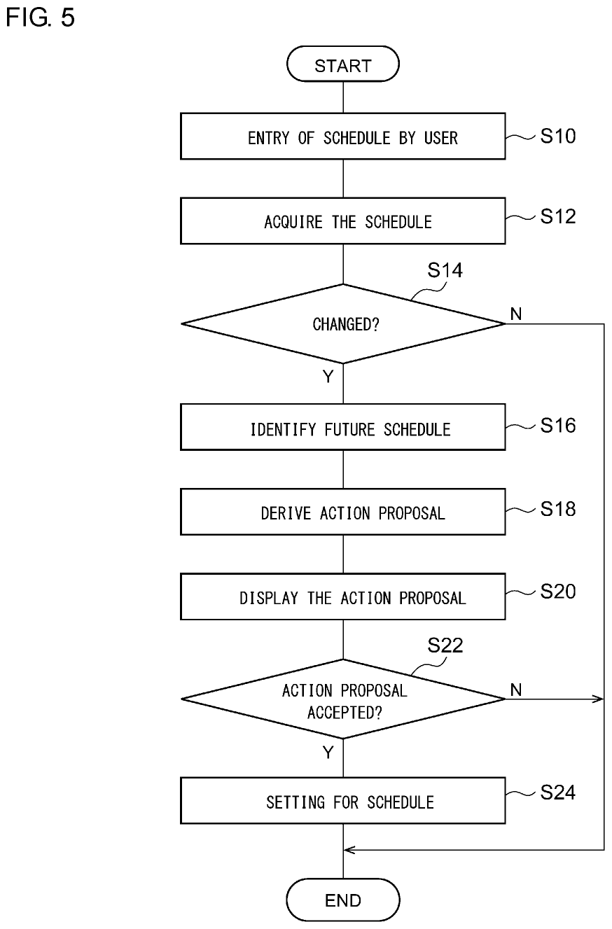

FIG. 4 is a diagram used to describe a functional configuration of the schedule management device 10. Each of the elements represented by functional blocks for performing various processes shown in FIG. 4 can be implemented by a circuit block, a memory, an LSI or the like in terms of hardware, and by a program loaded into a memory or the like in terms of software. Accordingly, it will be obvious to those skilled in the art that these functional blocks may be implemented in a variety of forms by hardware only, software only, or a combination thereof, and the form is not limited to any of them.

The schedule management device 10 includes a user information acquirer 20, a schedule acquirer 22, an identification unit 24, a vacant time detector 26, a proposal information retaining unit 28, a deriver 30, and a setting unit 32.

The user information acquirer 20 acquires the user information including the profile information and the position information. The position information includes action information of the user related to map information, and may include information of a shop where the user has visited, for example. The profile information is acquired through user input and includes information indicating preferences of the user. The profile information and action information of a user corresponds to information indicating action characteristics of the user and is used to judge the importance of a schedule item.

The schedule acquirer 22 acquires schedule information from the schedule provision device 14. Each schedule item in the schedule information includes information regarding the scheduled time, subject, place, and participants, and may further include information indicating the importance of the schedule item. The information indicating the importance of the schedule item may be presented, for example, in three levels, such as “high”, “middle”, and “low”, and may be set by user input.

When the start time of a schedule item is delayed or when the finish time thereof is advanced, the vacant time detector 26 detects the difference from the original start time or the original finish time as a vacant time of the user.

Besides the case where an input operation for changing the scheduled time of an original schedule item is performed, the vacant time detector 26 may detect a vacant time by identifying a change in the scheduled time of a schedule item based on the position information of the mobile terminal 12.

Based on the position information of the mobile terminal 12 acquired from the user information acquirer 20, the vacant time detector 26 identifies a change in the scheduled time of a schedule item to detect a vacant time. More specifically, the vacant time detector 26 follows the position information of the mobile terminal 12 and identifies, as an actual finish time, the time when the mobile terminal 12 becomes distant, by a predetermined distance or more, from the place specified in the schedule item currently performed, and, when the actual finish time is earlier than the original finish time set in the schedule item, the vacant time detector 26 detects, as a vacant time, the difference between the actual finish time and the original finish time. Thus, a vacant time can be detected by monitoring if the scheduled time of a schedule item is changed, based on the position information of the mobile terminal 12.

The proposal information retaining unit 28 retains action proposal information. The proposal information retaining unit 28 may acquire action proposal information from an external server device. The action proposal information includes information for introducing a shop, and information of coupons that can be used in the shop.

The deriver 30 derives action proposal information available for the detected vacant time and related to the action plan of a future schedule item subsequent to the vacant time. For example, if the subject of a future schedule item is skiing, the deriver 30 may derive action proposal information introducing a ski shop. Also, if the subject of a future schedule item is camping, the deriver 30 may derive action proposal information introducing an outdoor shop. Thus, by providing an action proposal for a detected vacant time related to a future schedule item, an effective proposal attractive to the user can be offered.

A derived action proposal information offers an action plan that can be carried out by the user in time for the next schedule item and is appropriately derived based on the length of the vacant time. For example, if the length of the vacant time is 30 minutes, a shopping store or a coffee shop located near the user may be introduced. If the length of the vacant time is one hour, a shop for meals located near the user or a shopping store located at a distance from the user may also be introduced. For a future schedule item, multiple pieces of action proposal information may be derived. Also, the traveling time of the user is calculated before the action proposal information is derived.

The identification unit 24 acquires the importance of each of multiple future schedule items subsequent to a vacant time, and identifies a future schedule item to which action proposal information to be derived relates, based on the acquired importance. The importance of each schedule item may be entered by the user, or may be calculated based on the user information. The identification unit 24 deduces an action plan preferred by the user based on the user information, and identifies a schedule item indicating an action plan preferred by the user, as a schedule item of which the importance is high.

The deriver 30 derives action proposal information related to the action plan of the schedule item thus identified based on the importance. The identification unit 24 identifies a schedule item of which the importance is high, and the deriver 30 derives action proposal information related to the action plan of the schedule item thus identified. Thus, by providing an action proposal related to a schedule item of which the importance is higher among multiple schedule items, an effective proposal can be offered. Also, multiple pieces of action proposal information may be derived for each of the schedule items in descending order of importance.

When a user has accepted action proposal information proposed to the user, the setting unit 32 adds the action proposal information thus accepted to the schedule information managed by the schedule management device 10 to set a new schedule item. Accordingly, when a user accepts action proposal information, rescheduling is automatically performed, which is highly convenient. Accepting action proposal information by a user may be performing, by the user, an operation for selecting execution of one of pieces of action proposal information displayed on the mobile terminal 12, for example.

When the setting unit 32 sets a new schedule item based on the action proposal information, as shown in FIG. 3B, the traveling item 42 may be changed. For example, when a shop introduced in the action proposal information is distant from the current position of the user, a traveling item for traveling from the shop to the place of the next schedule item is newly added to the schedule information.

The action proposal information derived by the deriver 30 may be indirectly transmitted to the mobile terminal 12 via the schedule provision device 14, or may be directly transmitted from the schedule management device 10 to the mobile terminal 12. The action proposal information may not only be displayed when the schedule information as shown in FIG. 3A is displayed on the mobile terminal 12, but also transmitted to the mobile terminal 12 via push notification. For example, when action proposal information is derived by the deriver 30, the setting unit 32 may transmit the action proposal information to the mobile terminal 12 via push notification or the like.

The mobile terminal 12 transmits, to the user information acquirer 20, information indicating whether the action proposal information proposed to the user has been accepted or rejected. The deriver 30 lowers the priority of proposing the action proposal information, based on the information indicating that the proposal information proposed to the user has been rejected. When the proposal information proposed to the user has been accepted and carried out by the user, the deriver 30 may be set not to derive the action proposal information until a predetermined period of time elapses.

FIG. 5 is a flowchart of processing for proposing an action for a vacant time. A user enters schedule information into the mobile terminal 12 (S10), and the schedule information is transmitted to the schedule provision device 14. From the schedule provision device 14, the schedule acquirer 22 acquires the schedule information thus entered (S12).

The vacant time detector 26 monitors if the scheduled time of a schedule item of the user is changed (S14), and, when the scheduled time is not changed (N at S14), the processing is terminated. When the scheduled time of a schedule item of the user is changed to be shorter (Y at S14), the difference between the original start time or finish time and the changed start time or finish time is detected as a vacant time.

Among multiple future schedule items subsequent to the vacant time, the identification unit 24 identifies a schedule item of which the importance is higher (S16). The deriver 30 then derives action proposal information available for the detected vacant time and related to the action plan of the schedule item thus identified (S18).

The setting unit 32 transmits the action proposal information thus derived to the schedule provision device 14 or the mobile terminal 12, and the mobile terminal 12 displays the action proposal information (S20). When the user performs an input operation for accepting the action proposal information thus provided and the setting unit 32 acquires the input information (Y at S22), the setting unit 32 adds the action proposal information thus accepted to the schedule information managed by the schedule management device 10 to set a new schedule item (S24). When the user rejects the action proposal information provided (N at S22), the processing is terminated.

The embodiment is intended to be illustrative only, and it will be obvious to those skilled in the art that various modifications to a combination of constituting elements could be developed and that such modifications also fall within the scope of the present disclosure.

Although the embodiment describes a mode in which the schedule provision device 14 retaining schedule information intervenes between the schedule management device 10 and the mobile terminal 12, the mode is not limited thereto. For example, the mobile terminal 12 may retain schedule information, and the schedule acquirer 22 of the schedule management device 10 may acquire the schedule information from the mobile terminal 12. In this case, the setting unit 32 may update the schedule information in the mobile terminal 12.

1. A schedule management device, comprising:
a schedule acquirer configured to acquire schedule information of a user, in which a start time and a finish time are set; and
a vacant time detector configured to detect, when the start time of a schedule item in acquired schedule information is delayed or when the finish time of a schedule item in acquired schedule information is advanced, the difference from the original start time or the original finish time as a vacant time of the user.

2. The schedule management device of claim 1, further comprising a deriver configured to derive action proposal information available for a detected vacant time and related to the action plan of a future schedule item.

3. The schedule management device of claim 2, further comprising an identification unit configured to acquire importance of each of a plurality of future schedule items subsequent to a vacant time, and identify a future schedule item to which action proposal information to be derived relates, on the basis of the acquired importance.

4. The schedule management device of claim 2, further comprising a setting unit configured to add, when a user has accepted action proposal information proposed to the user, the action proposal information thus accepted to the schedule information to set a new schedule item.

5. A schedule management method, comprising:
acquiring schedule information of a user, in which a start time and a finish time are set; and
detecting, when the start time of a schedule item in acquired schedule information is delayed or when the finish time of a schedule item in acquired schedule information is advanced, the difference from the original start time or the original finish time as a vacant time of the user.

6. The schedule management device of claim 3, further comprising a setting unit configured to add, when a user has accepted action proposal information proposed to the user, the action proposal information thus accepted to the schedule information to set a new schedule item.
